(19) United States
(12) Patent Application Publication
(10) Pub. No.: US 2008/0151115 A1
(43) Pub. Date: Jun. 26, 2008

(54) IMAGE PROCESSING APPARATUS

(75) Inventors: Budi Hartanto Agung, Tokyo (JP); Takashi Taniguchi, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/942,928

(22) Filed: Nov. 20, 2007

(30) Foreign Application Priority Data
Nov. 22, 2006 (JP) 2006-316151

(51) Int. Cl. H04N 9/64

(52) U.S. Cl. 348/510; 348/E05.1

(57) ABSTRACT

An image processing apparatus is provided that is capable of performing combining processing of image from image processing sections without the intermediation of a frame buffer, and can reduce the delay between image input and display and improve real-time capability. An image processing main chip 110 of a three-input image processing system 100 reads image data stored in frame buffers of storage apparatuses 117 through 119 in accordance with the line frequency of a display section 114, collects, in line units, image data processed by image processing subchips 111 and 112, performs combining processing in line units of the collected image data and image data it has processed itself, and outputs the combined data to display section 114, and image processing subchips 111 and 112 transfer processed image data to image processing main chip 110 in line units.

### CROSS REFERENCE TO RELATED APPLICATIONS

The disclosure of Japanese Patent Application No. 2006-316151, filed on Nov. 22, 2006, including the specification, drawings and abstract is incorporated herein by reference in its entirety.

### BACKGROUND OF THE INVENTION

1. Field of the Invention

The present invention relates to an image processing apparatus, and more particularly to an image processing apparatus that performs image processing of image captured from a camera or the like using a plurality of image processing chips.

2. Description of the Related Art

When configuring an image processing system that performs processing of a plurality of image inputs, the system can be configured by using a chip having image capture functions and image processing functions equivalent to the number of image inputs.

For example, in Patent Document 1 (Japanese Patent Application Laid-Open No. 2004-88474) an image processing apparatus is disclosed that is equipped with a camera movement estimation section that estimates a protruding part estimated to protrude from a frame, image storage memory that stores a protruding part, and an image combining section that creates an image by combining a plurality of protruding parts, and more widely recognizes broadcast image space.

Also, in Patent Document 2 (Japanese Patent Application Laid-Open No. 2002-229933), an image processing system is disclosed whereby memory capacity is decreased and the amount of transfer data per unit time is increased by making use of part of the bus width not used in the data transfer method.

FIG. 1 is a block diagram showing an image processing system that handles two image inputs.

In FIG. 1, an image processing system 10 is configured by means of two image source sections 11 and 12 (image source sections <1> and <2>), an image processing chip 13, a display section 14, a CPU 15, storage apparatuses 16 and 17 (storage apparatuses <1> and <2>), and a bus 18.

Image processing chip 13 is composed of two image input sections 21 and 22, an image processing section 23 capable of processing two image inputs, and an image output section 24, and performs capture and processing of two image inputs.

When configuring a system in which the number of image inputs differs, it is necessary to provide various chips capable of handling the respective image inputs. However, if it is difficult from a scheduling or cost viewpoint to develop all the various chips, a system cannot be configured in a scalable fashion. Also, in the case of an image processing system with many image inputs, it is necessary to incorporate many image capture functions, and the image processing load further increases, making it difficult to perform all image capture and image processing with a single image processing chip.

On the other hand, if processing is distributed among a plurality of image processing chips and the image inputs processed by the various chips are combined, the image from each chip is temporarily stored in a frame buffer before being combined and displayed, with the result that there is a long delay between image input and display, and real-time capability suffers.

FIG. 2 is a block diagram showing an example of a four-input image processing system capable of handling four image inputs.

In FIG. 2, a four-input image processing system 30 is configured by means of four image source sections 31 through 34 (image source sections <1> through <4>), image processing chips 41 and 42, an image combining chip 43, a display section 44, a CPU 45, storage apparatuses 46 through 49 (storage apparatuses <1> through <4>), and a bus 50.

Image combining chip 43 is composed of two image input sections 51 and 52, an image combining section 53 capable of processing two image inputs, and an image output section 54.

Image processing chips 41 and 42 have the same configuration as image processing chip 13 in FIG. 1.

The image processing system shown in FIG. 2 comprises an image processing system capable of handling four-input image using image processing chips 41 and 42 each capable of handling two image inputs.

Image from image source section 31 and image source section 32 is captured and processed by image processing chip 41, and image from image source section 33 and image source section 34 is captured and processed by image processing chip 42. Then image processed by image processing chip 41 and image processed by image processing chip 42 are combined by image combining chip 43 and displayed. The operations up to combining and display of output image from image processing chip 41 and image processing chip 42 are as follows.

FIG. 3 is a drawing explaining operations up to combining and display of output image from image processing chip <1> and image processing chip <2> of four-input image processing system 30 in FIG. 2. Arrows indicated by reference numbers (1) through (5) in FIG. 3 show the data flow.

(1) Image Data Capture→(2) Image Data Processing→(3) Image Data Capture

First, output image from image processing chip <1> is captured by image input section 51 (FIG. 2), and the captured data is stored in a frame buffer in storage apparatus <4>. In the same way, output image from image processing chip <2> is captured by image input section 52 (FIG. 2), and the data is stored in a frame buffer in storage apparatus <4>.

(4) Image Combining Processing

Then image combining section 53 reads the two image data stored in the above-mentioned frame buffers, combines them, and writes the combined data back to an output frame buffer in storage apparatus <4>.

(5) Display Processing

Image output section 54 reads image data stored in the output frame buffer of storage apparatus <4>, and outputs this image data to display section 44.

In (3) above, since data is transferred asynchronously and in frame units from image processing chips <1> and <2> to the image combining chip, it is necessary for data from image processing chips <1> and <2> to be temporarily held in storage apparatus <4> before image processing chip <1> and <2> combining processing is performed.

Thus, it is necessary for image to pass through a frame buffer twice between capture of output image from image processing chip <1> and image processing chip <2>, and image combining and display.

However, with this kind of conventional image processing system, in a system that has a configuration whereby input image processing is performed by a plurality of chips and the image inputs processed by the respective image processing chips are then combined, there is a problem of lengthy overall system processing delay, and a lack of real-time capability.

That is to say, there is a need for a means of enabling an image processing system to be configured in a scalable fashion in line with the number of image inputs and image processing load. However, processing of multi-input image imposes a heavy load, and is difficult to perform with a single chip. On the other hand, if processing is distributed among a plurality of image processing chips and the image inputs processed by the various chips are combined, the image from each chip is temporarily stored in a frame buffer before being combined and displayed, with the result that there is a long delay between image input and display, and real-time capability suffers.

### SUMMARY OF THE INVENTION

It is an object of the present invention to provide an image processing apparatus that is capable of performing combining processing of image from image processing sections without the intermediation of a frame buffer, and can reduce the delay between image input and display and improve real-time capability.

It is a further object of the present invention to provide an image processing apparatus that enables a system to be constructed in a scalable fashion in line with the number of image inputs, image processing load, and so forth.

According to an aspect of the invention, an image processing apparatus is equipped with one or a plurality of image sources that supply image composed of frame-unit images, a plurality of image processing sections that process image from the image source(s), a storage section that has a frame buffer that stores one screen of input image, and a display section that displays image data that has undergone image processing by the image processing section; wherein the image processing section is composed of a first image processing section that reads image data stored in the frame buffer in-line units in accordance with the line frequency of the display section, performs combining processing of that image data in line units, and outputs that image data to the display section, and a second image processing section that does not perform the combining processing; and the first and second image processing sections are equipped with a data transfer section that transfers image in line units in accordance with the line frequency of the display section.

### BRIEF DESCRIPTION OF THE DRAWINGS

FIG. 1 is a block diagram showing a conventional image processing system that handles two image inputs;

FIG. 2 is a block diagram showing an example of a conventional four-input image processing system;

FIG. 3 is a drawing explaining operations up to combining and display of output image of a conventional four-input image processing system;

FIG. 4 is a block diagram showing the configuration of an image processing system according to Embodiment 1 of the present invention;

FIG. 5 is a drawing showing the configuration of an image processing main chip of an image processing system according to above Embodiment 1;

FIG. 6 is a drawing showing the configuration of an image processing subchip of an image processing system according to above Embodiment 1;

FIG. 7 is a drawing explaining the operation of a two-input image processing system forming part of an image processing system according to above Embodiment 1;

FIG. 8 is a drawing explaining synchronization of a line-unit combining processing section and display section of an image processing system according to above Embodiment 1;

FIG. 9 is a block diagram showing the configuration of an image processing system according to Embodiment 2 of the present invention;

FIG. 10 is a block diagram showing the configuration of an image processing combined main/subchip of an image processing system according to Embodiment 2 of the present invention;

FIG. 11 is a block diagram showing the configuration of an image processing system according to Embodiment 3 of the present invention;

FIG. 12 is a block diagram showing the configuration of an image processing system according to Embodiment 4 of the present invention;

FIG. 13 is a block diagram showing the configuration of an image processing system according to Embodiment 5 of the present invention;

FIG. 14 is a block diagram showing the configuration of an image processing system according to Embodiment 6 of the present invention;

FIG. 15 is a block diagram showing the configuration of an image processing system according to Embodiment 7 of the present invention;

FIG. 16 is a drawing showing an example of a case in which image processing division is performed in the screen horizontal direction of an image processing system according to above Embodiment 7; and

FIG. 17 is a drawing showing an example of a case in which image processing division is performed in the screen vertical direction of an image processing system according to above Embodiment 7.

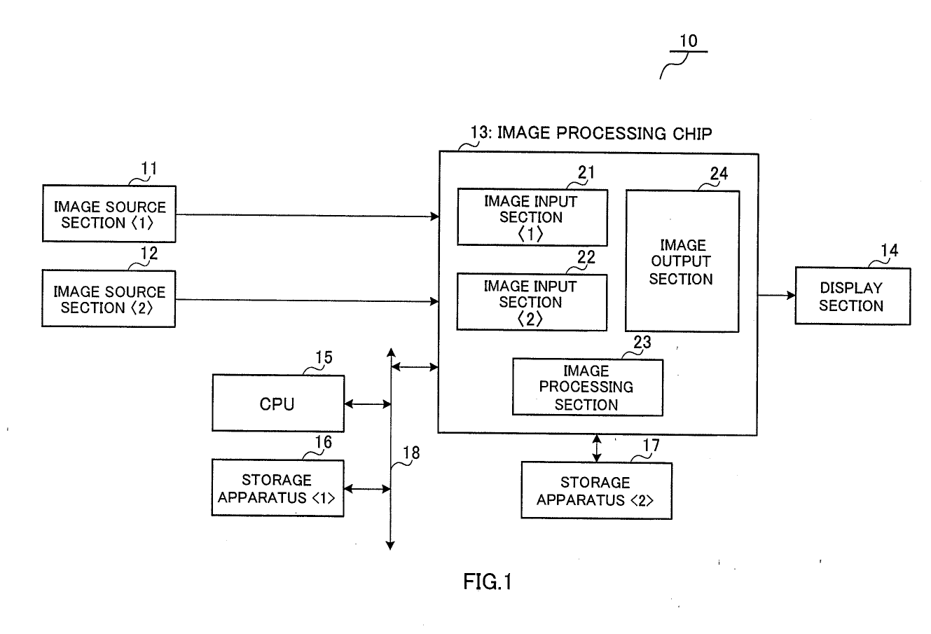

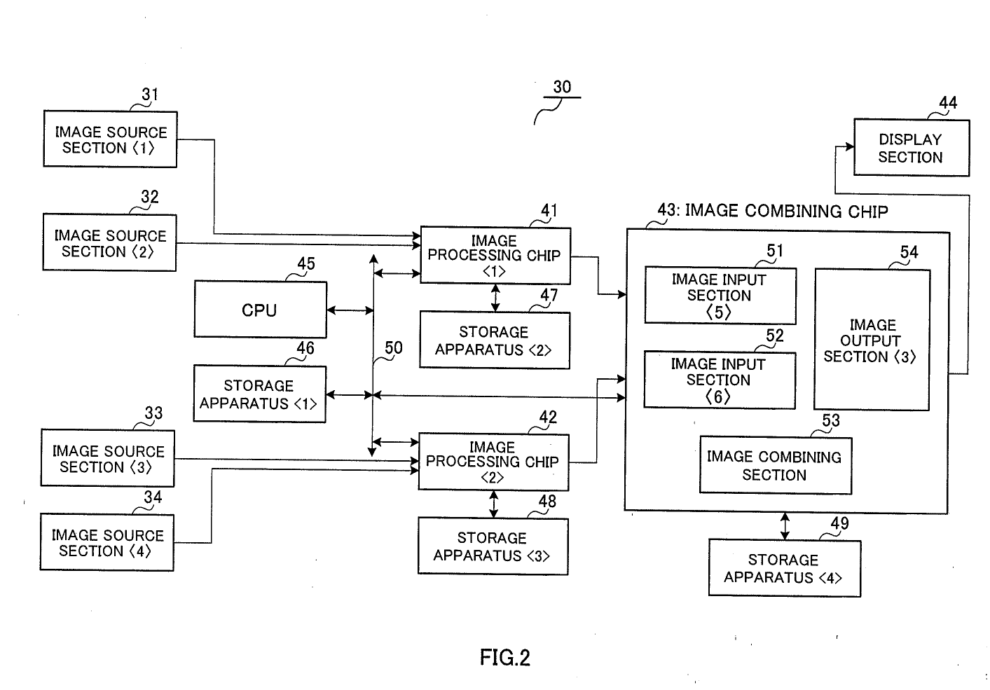

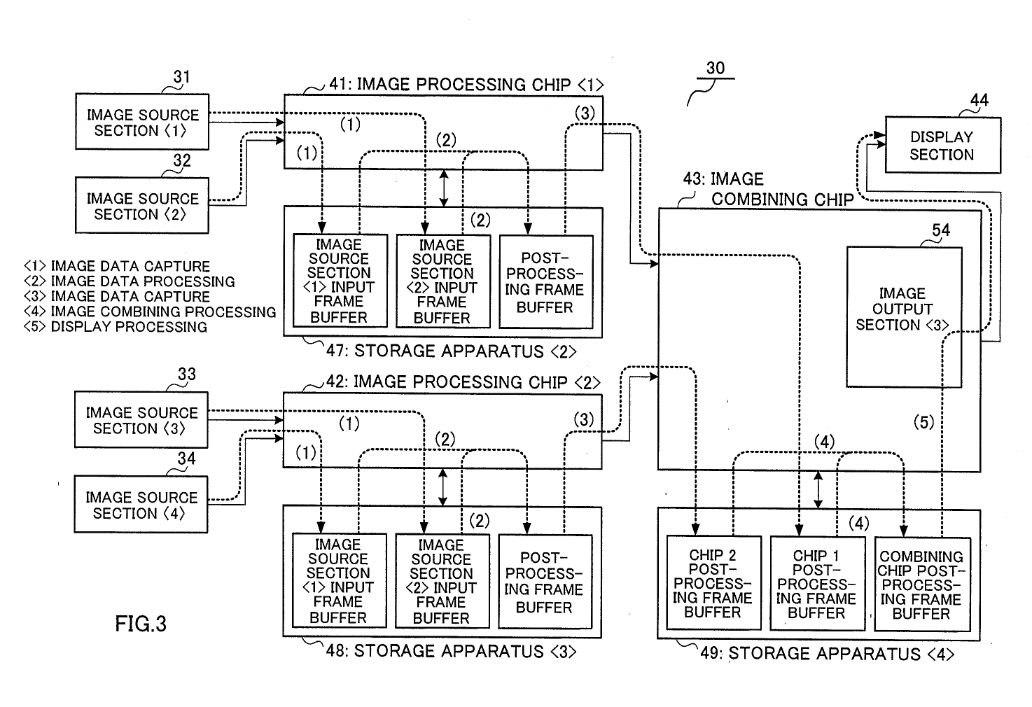

### DETAILED DESCRIPTION OF THE PREFERRED EMBODIMENTS

With reference now to the accompanying drawings, embodiments of the present invention will be explained in detail below.

### Embodiment 1

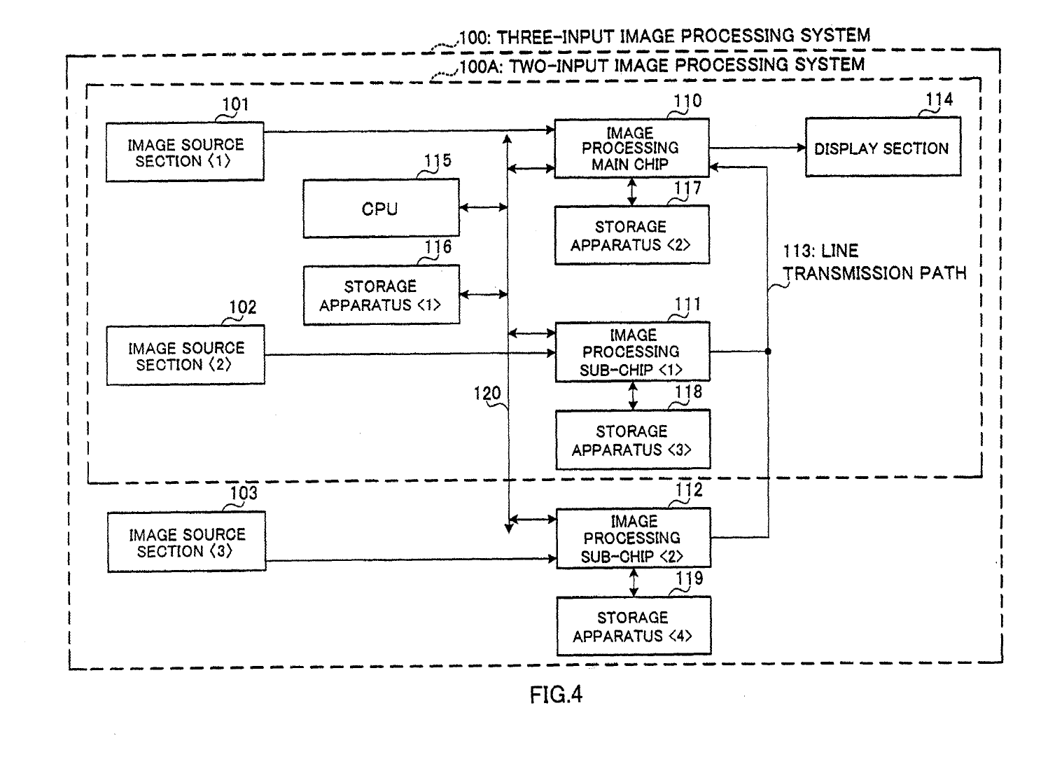

FIG. 4 is a block diagram showing the configuration of an image processing system according to Embodiment 1 of the present invention. This embodiment is an example of application to a three-input image processing system using one image processing main chip and a plurality of image processing subchips.

In FIG. 4, a three-input image processing system 100 is configured by means of an image source section 101 (image source section <1>), an image source section 102 (image source section <2>), an image source section 103 (image source section <3>), an image processing main chip 110 having a line-unit transfer function and line-unit combining processing-function, an image processing subchip 111 (image processing subchip <1>) having a line-unit transfer function, an image processing subchip 112 (image processing subchip <2>) having a line-unit transfer function, a line transmission path 113, a display section 114, a CPU 115, a storage apparatus 116 (storage apparatus <1>), a storage apparatus 117 (storage apparatus <2>), a storage apparatus 118 (storage apparatus <3>), a storage apparatus 119 (storage apparatus <4>), and a bus 120.

Within three-input image processing system 100, image source section 101 (image source section <1>), image source section 102 (image source section <2>), image processing main chip 110, image processing subchip 111 (image processing subchip <1>), line transmission path 113, display section 114, CPU 115, storage apparatuses 116 through 118 (storage apparatuses <1> through <3>), and bus 120, compose a two-input image processing system 100A. Also, although omitted from the drawing, within three-input image processing system 100, there may be a two-input image processing system 100B configured by means of image source section 103 (image source section <3>), image processing subchip 112 (image processing subchip <2>), and storage apparatus 119 (storage apparatus <4>), instead of image source section 102 (image source section <2>), image processing subchip 111 (image processing subchip <1>), and storage apparatus 118 (storage apparatus <3>), having the same kind of function as two-input image processing system 100A.

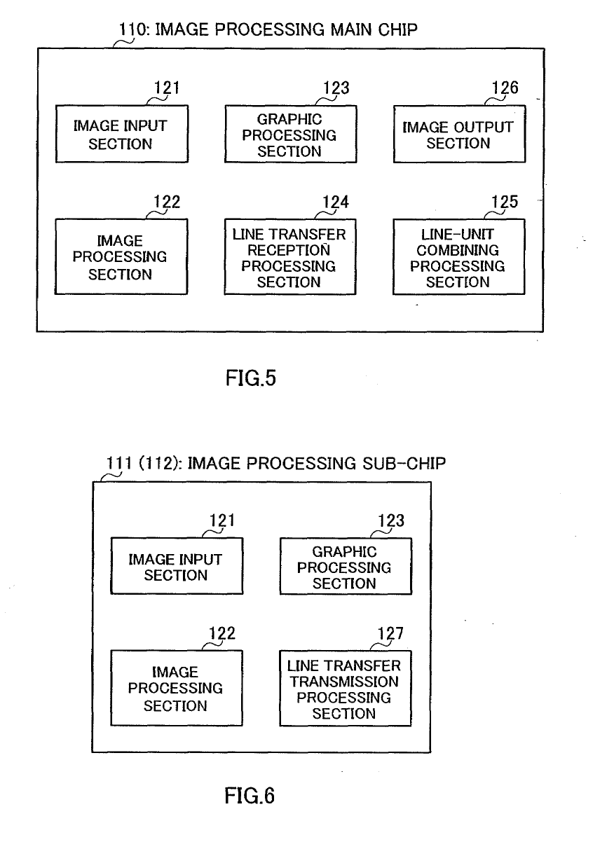

Image processing main chip 110 and image processing subchips 111 and 112 are image processing chips that perform image input capture, image processing, and graphic processing, and have a line-unit transfer function. Image processing subchips 111 and 112 have a line transfer transmission processing section 127 (FIG. 6), and image processing main chip 110 has a line transfer reception processing section 124 (FIG. 5) and a line-unit combining processing section 125 (FIG. 5). Details will be given later herein with reference to FIG. 5 and FIG. 6.

Image processing main chip 110 requests one line of image or graphic data (hereinafter referred to as line data) from another chip, collects line data, and combines the collected line data in line units.

Image processing subchips 111 and 112 issue a response to a line data transfer request from another chip, and transmit line data of the requested specification.

Line transmission path 113 is, for example, a line transfer bus, comprising MODE signal, DATA signal, and VALID signal buses. The MODE signal bus is for notifying an image processing subchip of the transfer type, such as chip select mode, line number transfer mode, image data transfer mode, and so forth, and the image processing main chip always has usage authority for this bus. The DATA signal bus is for transferring chip select data, line number data, image data, and so forth. The VALID signal bus is for notification from the sending side to the receiving side as to whether or not data transferred to the DATA bus is valid.

Three-input image processing system 100 performs image capture, processing of captured image, graphic processing, and processing for combining image and graphics, and outputs processed image or graphics or image and graphics to a display system. For example, three-input image processing system 100 performs image capture, distortion correction processing for captured image, filtering processing, image chromacity/luminance correction processing, viewpoint conversion processing, processing for combining overlapping image between cameras, image analysis processing for the purpose of analyzing an image captured from a camera and detecting obstructions, people, white lines on roads, and so forth, graphic processing such as vehicle graphic drawing, guideline drawing, character drawing, setting screen drawing, menu button drawing, and the like, and processing for combining image and graphics, and outputs processed image or graphics or image and graphics to a display system.

A feature of three-input image processing system 100 is that image data created among different chips are transferred in line units, collected in the main chip, combined, and displayed, in accordance with the display line frequency of display section 114.

In FIG. 4, three-input image processing system 100 processes a plurality of image inputs divided among one image processing main chip 110 and two image processing subchips 111 and 112. Specifically, three-input image processing system 100 has a step of capturing a plurality of image inputs divided among a plurality of image processing chips incorporating a line-unit transfer function, a step of performing image processing and graphic processing by means of the image processing chips, a step of collecting image, graphic, or combined image and graphic data processed by the image processing chips in line units and performing line combining, and a step of outputting combined line data to a display system.

As the above-described line-unit transfer function, a method is used whereby the image processing chip (the image processing main chip) that performs combining processing of image processed by the image processing chips provides a chip select signal or request signal and line number information to an image processing chip other than the image processing main chip or graphic processing chip (image processing subchip), and the selected image processing subchip transfers line data corresponding to the line number.

Alternatively, as the above-described line-unit transfer function, a method is used whereby the image processing main chip provides a chip select signal or request signal, line number information, and also valid data range information necessary for combining, to an image processing subchip, and the selected image processing subchip transfers only valid data corresponding to the line number.

FIG. 5 is a drawing showing the configuration of above-described image processing main chip 110.

In FIG. 5, image processing main chip 110 is configured by means of an image input section 121, an image processing section 122, a graphic processing section 123, a line transfer reception processing section 124, a line-unit combining processing section 125, and an image output section 126.

Image input section 121 captures one or a plurality of image inputs, and stores the captured data in a specified input frame buffer.

Image processing section 122 reads image data from the specified frame buffer, performs image processing such as pixel combining and pixel rearrangement, and stores the processed data in a specified buffer.

Graphic processing section 123 performs graphic drawing processing, graphic image superimposition processing, and processing to store processed data in a specified buffer.

Line transfer reception processing section 124 performs line data requests to another chip, reception of line data transmitted from another chip, issuance of a response to another chip that has transmitted line data, and storage of received line data in a specified buffer.

Line-unit combining processing section 125 performs reading of line data stored in a specified plurality of line buffers and processing for combining a specified plurality of line data in a specified order, and stores combined data in a specified line buffer.

Image output section 126 reads and outputs image data stored in a specified buffer.

FIG. 6 is a drawing showing the configuration of image processing subchip 111. Image processing subchip 111 (image processing subchip <1>) and image processing subchip 112 (image processing subchip <2>) have identical configurations, and therefore image processing subchip 111 is shown here as a representative example. Configuration parts identical to those in FIG. 5 are assigned the same reference codes as in FIG. 5, and descriptions thereof are omitted.

In FIG. 6, image processing subchip 111 is configured by means of an image input section 121, an image processing section 122, a graphic processing section 123, and a line transfer transmission processing section 127.

Line transfer transmission processing section 127 responds to a request for line data from another chip, reads specified line data requested by another chip from a specified frame buffer or line buffer, and transmits specified line data requested by another chip.

The operation of an image processing system configured as described above will now be explained.

Three-input image processing system 100 is divided into a two-input image processing system 101A and a two-input image processing system 100B not shown in the drawing. The operation of two-input image processing system 100A and two-input image processing system 100B forms the basic operation of three-input image processing system 100. To simplify the description of the operation, image processing subchip 111 (image processing subchip <1>) and image processing subchip 112 (image processing subchip <2>) will be referred to simply as image processing subchip <1> and image processing subchip <2>.

[Overall Operation of Two-Input Image Processing System 100A]

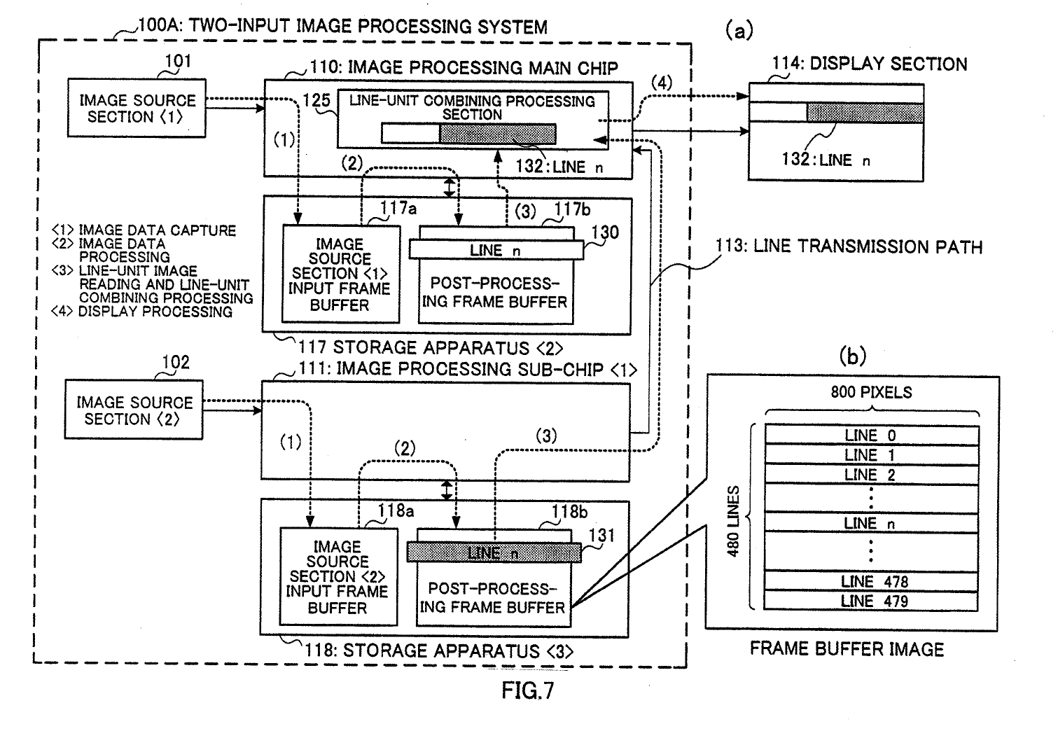

FIG. 7 is a drawing explaining the operation of a two-input image processing system forming part of three-input image processing system 100, in which FIG. 7(a) shows an overall diagram of three-input image processing system 100 and FIG. 7(b) shows an example of frame buffer operation after line processing. A feature of an image processing system of this embodiment is that image data created among different chips are transferred in line units and collected and combined in the main chip, and FIG. 7 shows an image of the line-unit processing. Arrows indicated by reference numbers (1) through (4) in FIG. 7 show the data flow.

[Image Data Capture]

Image processing main chip 110 is connected to image processing subchip <1> and image processing subchip <2> by means of line transmission path 113 so as to enable line data transfer. Image processing main chip 110 captures image from image source section 101 (image source section <1>) and stores it in an input frame buffer in storage apparatus 117 (storage apparatus <2>). Here, image from image source section <1> is stored in input frame buffer 117a as indicated by reference number (1) in FIG. 7(a).

[Image Data Processing]

Next, image data stored in input frame buffer 117a of storage apparatus <2> undergoes image processing specified by CPU 115, undergoes graphic processing specified by CPU 115, or undergoes graphic data and image data combining processing, and the processed data is stored in output frame buffer 117b in storage apparatus <2>. Here, image data stored in input frame buffer 117a is processed and stored in output frame buffer 117b in storage apparatus <2> as indicated by reference number (2) in FIG. 7(a).

The above describes the operations whereby image processing main chip 110 captures image data from image source section <1> and temporarily stores this data in input frame buffer 117a of storage apparatus <2>, performs image processing and so forth on the image data stored in this input frame buffer 117a, and holds this image data in output frame buffer 117b of storage apparatus <2>.

The same kind of operations are also executed between image source section <2> and image processing subchip <1>, and between image source section <3> and image processing subchip <2>. Two-input image processing system 100A in FIG. 7 shows the operation of image source section <2> and image processing subchip <1> as a representative example, and image source section <2> and image processing subchip <1> perform the same kind of processing as image source section <1> and image processing main chip 110 described above using storage apparatus <3> for image from image source section <2> in the same way as image source section <1> and image processing main chip 110. That is to say, image processing subchip <1> captures image data from image source section <2> and temporarily stores this data in input frame buffer 118a of storage apparatus <3>, performs image processing and so forth on the image data stored in this input frame buffer 118a, and holds this image data in output frame buffer 118b of storage apparatus <3>.

[Line-Unit Image Reading and Line-Unit Combining Processing]

### 1. Line-Unit Image Reading

Image processing main chip 110 requests write data from image processing subchip <1> and image processing subchip <2> based on line combining processing parameters specified by CPU 115 (a parameter indicating the order in which combining should be performed, a combining area, combining blend ratio or suchlike parameter, or the like). In response to this, image processing subchip <1> and image processing subchip <2> read the line data requested by image processing main chip 110 from output frame buffers 117b and 118b in storage apparatus 117 (storage apparatus <2>) and storage apparatus 118 (storage apparatus <3>) respectively, and transmit this line data to image processing main chip 110, as indicated by reference number (3) in FIG. 7(a).

FIG. 7(b) is a drawing showing an example of the configuration of output frame buffer 118b of storage apparatus 118 (storage apparatus <3>) of two-input image processing system 100A. As shown in FIG. 7(b), output frame buffer 118b has a 480-line×800-pixel storage area, and stores data in line units. Thus, processed data is stored in output frame buffers 117b and 118b in line units.

### 2. Line-Unit Combining Processing

Next, image processing main chip 110 performs combining processing of line data transmitted in line units from image processing subchips <1> and <2> and line data processed by image processing main chip 110 itself, using a specified order and blend ratio, and stores the combined data in a post-combining frame buffer. Line-unit combining processing section 125 performs line-unit combining processing in line units synchronized with the line frequency of display section 114. In the example shown in FIG. 7, line-unit combining processing section 125 performs line-unit combining processing of line n data 130 transmitted in line units from output frame buffer 117b of storage apparatus <2> and line n data 131 transmitted in line units from output frame buffer 118b of storage apparatus <3>, and stores line n data 132 after combining processing in its own frame buffer in line units.

[Display Processing]

After combining line data transferred in line units from image processing subchips <1> and <2> in line units, line-unit combining processing section 125 stores that line data in a post-combining frame buffer. Then image output section 126 (FIG. 5) reads post-combining-processing line n data 132 stored in the post-combining frame buffer and transmits it directly to display section 114 in line units, as indicated by reference number (4) in FIG. 7(a). Since line n data 132 transmitted to display section 114 is data that has undergone line-unit combining processing synchronized with the line frequency of display section 114, it is possible for display section 114 to display the transmitted line data directly.

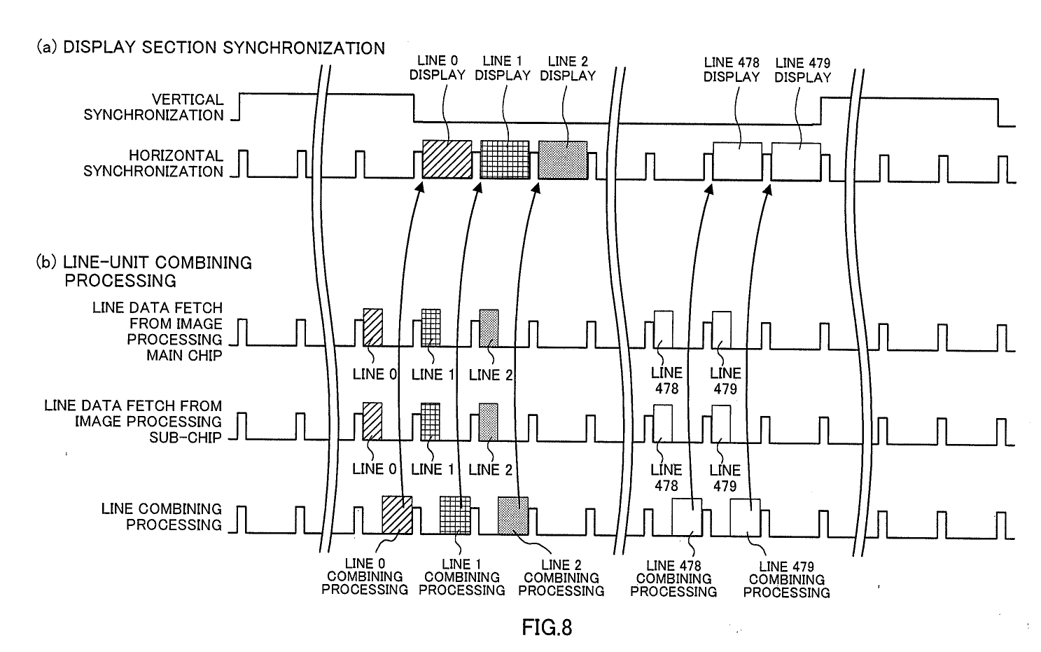

FIG. 8 is a drawing explaining synchronization of line-unit combining processing section 125 and display section 114.

As shown in FIG. 8(a), display section 114 performs frame period synchronization by means of vertical synchronization, and performs data line display synchronization by means of horizontal synchronization. In FIG. 8, line 0 display of one frame is started by means of horizontal synchronization at a vertical synchronization fall, and thereafter, line 1 display, . . . , line 479 display is performed at each horizontal synchronization, and line display of one frame is completed at a vertical synchronization-rise.

As shown in FIG. 8(b), two-input image processing system 100A performs line-unit data transfer and line-unit combining processing synchronized with the line frequency of display section 114 shown in FIG. 8(a). Specifically, three-input image processing system 100 extracts line data from image processing main chip 110, and also extracts line data from image processing subchips <1> and <2>, in accordance with display section 114 vertical synchronization and horizontal synchronization. Then line-unit combining processing section 125 performs line-unit combining processing synchronized with the line frequency of display section 114, and image output section 126 transmits line n data 132 after combining processing to display section 114 in line units (see the arrows in FIG. 8).

The above operations are the same for two-input image processing system 100B not shown in the drawings, and are also the same for three-input image processing system 100 combining the operations of two-input image processing system 100A and two-input image processing system 100B.

Next, the operation of image processing main chip 110 and image processing subchips 111 and 112 will be described in detail.

[Operation of Image Processing Main Chip 110]

The flow of the series of operations performed by three-input image processing system 100 is as follows.

As shown in FIG. 5, input image is captured by image input section 121 and data is stored in external input frame buffers (for example, input frame buffers 117a and 117b in FIG. 7). Then, based on an image processing parameter (a parameter indicating what kind of processing is to be performed on the original image, or the like), image processing section 122 reads data stored in the input frame buffers, performs processing, and stores the processed image in output frame buffers (for example, output frame buffers 117b and 118b in FIG. 7). Then, in order to perform line-unit combining, line transfer reception processing section 124 issues a request for line data to another chip (for example, image processing subchip 111 in FIG. 7), and stores the returned line data in a specified line buffer.

Line-unit combining processing section 125 combines and outputs the stored line data and data processed by the main chip itself.

Thus, in image processing main chip 110, the provision of line transfer reception processing section 124 and line-unit combining processing section 125 enables line-unit data requests and reception to be performed vis-à-vis another image processing chip, and makes it possible to perform line-unit combining.

Image processing main chip 110 shown in FIG. 5 has an image input section 121, image processing section 122, and graphic processing section 123, but may also be configured by means of one of these processing sections plus line transfer reception processing section 124, line-unit combining processing section 125, and image output section 126, or may be configured by means of line transfer reception processing section 124, line-unit combining processing section 125, and image output section 126.

[Operation of Image Processing Subchips 111 and 112]

The flow of the series of operations performed by image processing subchips 111 and 112 is as follows.

As shown in FIG. 6, input image is captured by image input section 121 and data is stored in an input frame buffer (for example, input frame buffer 118a in FIG. 7). Then, based on an image processing parameter, image processing section 122 reads data stored in the input frame buffer, performs processing, and stores the processed image in an output frame buffer (for example, output frame buffer 118b in FIG. 7). Then, in response to a request from image processing main chip 110, line transfer transmission processing section 127 reads specified line data from the output frame buffer and transmits this line data to image processing main chip 110.

Thus, in image processing subchips 111 and 112, the provision of line transfer transmission processing section 127 enables line data of a requested specification to be transmitted to another image processing chip.

Image processing subchip 111 shown in FIG. 6 has an image input section 121, image processing section 122, and graphic processing section 123, but may also be configured by means of one of these processing sections and line transfer transmission processing section 127.

As described above, according to this embodiment, three-input image processing system 100 is equipped with image source sections 101 through 103 (image source sections <1> through <3>) that supply image composed of frame-unit images, an image processing main chip 110 and image processing subchips 111 and 112 (image processing subchips <1> and <2>) that have a data transfer means that transfers image in line units in accordance with the line frequency of display section 114 and process image from image source sections 101 through 103, storage apparatuses 116 through 119 (storage apparatuses <1> through <4>) having a frame buffer that stores one screen of input image, and a display section 114 that displays image data that has undergone image processing by image processing main chip 110; wherein image processing main chip 110 reads image data stored in the frame buffers of storage apparatuses 117 through 119 in line units in accordance with the line frequency of display section 114, collects image data processed by image processing subchips 111 and 112 in line units, performs combining processing of the collected image data and image data processed by itself in line units, and outputs that image data to display section 114, and image processing subchips 111 and 112 have a configuration whereby processed image data is transferred to image processing main chip 110 in line units, so that data from each image processing chip is not held in a frame buffer before combining processing of image from each image processing chip is performed, and image combining processing can be performed without the intermediation of a frame buffer. By this means, the delay between image input and display can be reduced, and real-time capability can be improved. Also, using an image processing chip having an image line-unit transfer function enables a system to be constructed in a scalable fashion in line with the number of image inputs, image processing load, and so forth.

Thus, it is possible for image processing main chip 110 of three-input image processing system 100 to have line data for combining transferred to it in line units from image processing chips <1> and <2>, combine these line data, and then pass them directly to display section 114. In the example of conventional technology, since data is transferred asynchronously and in frame units from image processing chips to an image combining chip, it is necessary for data from the image processing chips to be held temporarily in frame buffers in a storage apparatus <4> before combining processing of image from the image processing chips is performed. In contrast, in this embodiment, line-unit data transfer and line-unit combining processing are synchronized with the line frequency of display section 114, making the use of an intermediate frame buffer unnecessary. That is to say, by performing line-unit transfer and line-unit combining of image from image processing chips <1> and <2>, image from the image processing chips can be combined without being temporarily stored in an input frame buffer. This embodiment therefore has an effect of enabling combining processing to be performed with a shorter delay compared with the conventional method of performing combining processing after temporarily storing image from image processing chips <1> and <2> in an input frame buffer.

Furthermore, by synchronizing an above-described series of operations, comprising a line data request from image processing main chip 110 to a subchip, line data transfer from a subchip, line data combining and output to display section 114, and so forth, with the line display frequency of display section 114, it is possible to output combined data directly to display section 114 without the intermediation of a post-combining frame buffer, and delay can be further suppressed.

In this embodiment, a three-input image processing system configuration has been shown, but it is also possible, for example, to configure a two-input image processing system with image processing main chip 110 and one subchip, or to configure a four-input image processing system using image processing main chip 110 and three subchips, configuring a system in a scalable fashion in line with the number of image inputs, image processing load, graphic processing load, and so forth.

In FIG. 4, image processing main chip 110 and the subchips are image processing chips handling one image input, but image processing chips handling a plurality of image inputs, or image processing chips having only a graphic processing function, can also be used. Furthermore, a graphic processing chip incorporating a line-unit transfer function may also be used in addition to a plurality of image processing chips.

### Embodiment 2

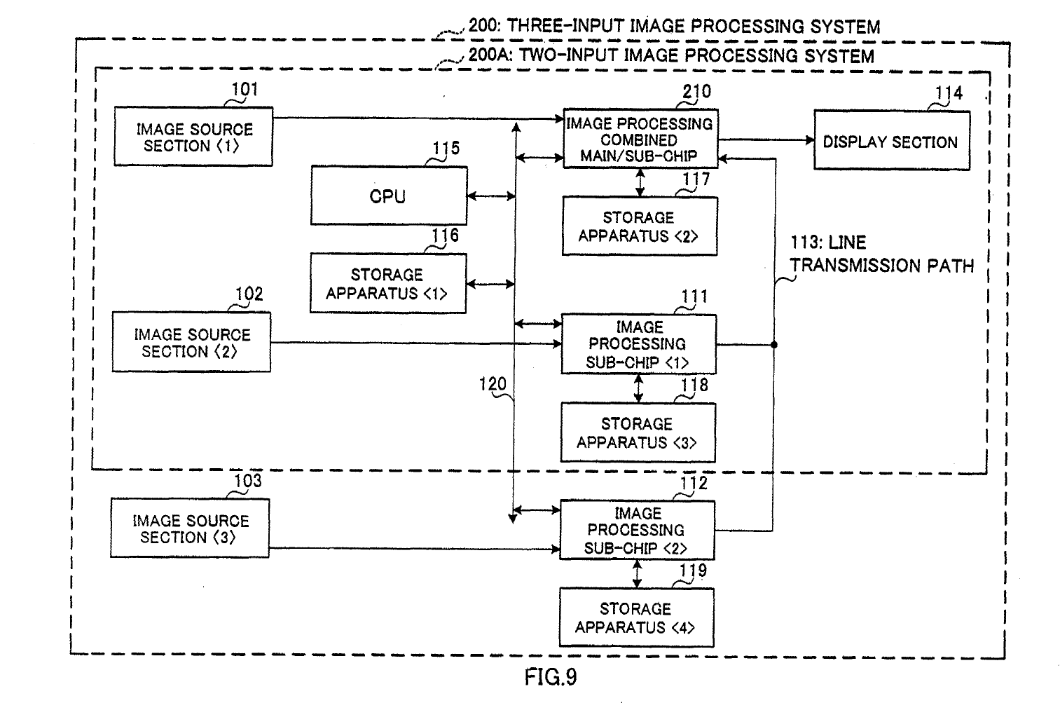

FIG. 9 is a block diagram showing the configuration of an image processing system according to Embodiment 2 of the present invention. This embodiment is an example of application of an image processing system using one image processing combined main/subchip and a plurality of image processing subchips. In the description of this embodiment, configuration parts identical to those in FIG. 4 are assigned the same reference codes as in FIG. 4, and duplicate descriptions are omitted.

In FIG. 9, a three-input image processing system 200 is configured by means of image source sections 101 through 103 (image source sections <1> through <3>), an image processing combined main/subchip 210 having a line-unit transfer function and line-unit combining processing function, an image processing subchip 111 (image processing subchip <1>) having a line-unit transfer function, an image processing subchip 112 (image processing subchip <2>) having a line-unit transfer function, a line transmission path 113, a display section 114, a CPU 115, storage apparatuses 116 through 119 (storage apparatuses <1> through <4>), and a bus 120.

Within three-input image processing system 200, image source section 101 (image source section <1>), image source section 102 (image source section <2>), image processing combined main/subchip 210, image processing subchip 111 (image processing subchip <1>), line transmission path 113, display section 114, CPU 115, storage apparatuses 116 through 118 (storage apparatuses <1> through <3>), and bus 120, compose a two-input image processing system 200A.

Image processing combined main/subchip 210 has both image processing main chip and image processing subchip functions. Image processing main chip functions are to request image line data from another image processing chip, collect line data, and combine the collected line data. Image processing subchip functions are to issue a response to a line data transfer request from another image processing chip, and transmit line data of the requested specification.

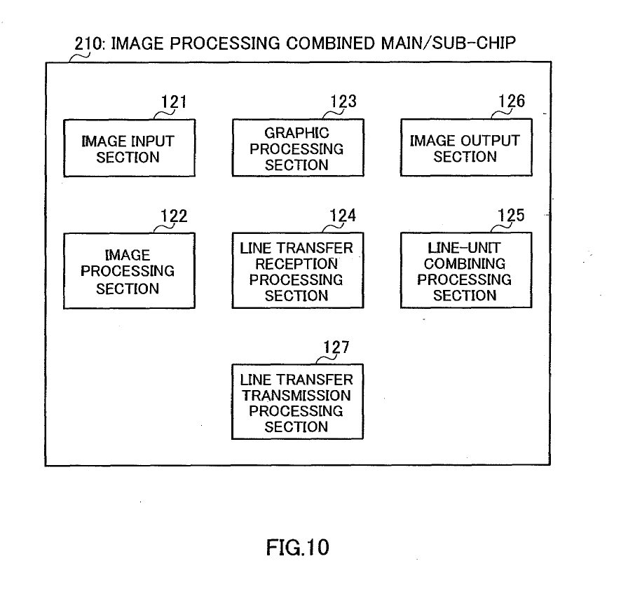

FIG. 10 is a block diagram showing the configuration of above-described image processing combined main/subchip 210. Configuration parts identical to those in FIG. 5 and FIG. 6 are assigned the same reference codes as in FIG. 5 and FIG. 6.

In FIG. 10, image processing combined main/subchip 210 is configured by means of an image input section 121, an image processing section 122, a graphic processing section 123, a line transfer reception processing section 124, a line-unit combining processing section 125, an image output section 126, and a line transfer transmission processing section 127.

When operating as an image processing main chip, image processing combined main/subchip 210 operates in the same way as image processing main chip 110 of Embodiment 1, and when operating as an image processing subchip, image processing combined main/subchip 210 performs the operations of image processing subchips 111 and 112. It is also possible for image processing combined main/subchip 210 to operate simultaneously as an image processing main chip and an image processing subchip.

The operation of an image processing system configured as described above will now be explained. The basic operation is the same as in Embodiment 1.

Here, image processing combined main/subchip 210 is assumed to be the image processing main chip, and image processing subchip 111 and image processing subchip 112 are assumed to be image processing subchip <1> and image processing subchip <2>. Image processing combined main/subchip 210 (here, the image processing main chip) and image processing subchips <1> and <2> are connected by line transmission path 113 so as to enable line data transfer.

Image processing combined main/subchip 210 (hereinafter referred to in this embodiment as the image processing main chip) captures image from image source section 101 (image source section <1>) and stores it in an input frame buffer in storage apparatus 117 (storage apparatus <2>).

Next, image processing specified by CPU 115 is performed on the stored image data, specified graphic processing is performed, and graphic data and image data combining processing is performed. Then the processed data is stored in an output frame buffer in storage apparatus 117 (storage apparatus <2>). The same kind of processing is performed by image processing subchip <1> and image processing subchip <2> on image from image source section 102 (image source section <2>) and image source section 103 (image source section <3>) using storage apparatus 118 (storage apparatus <3>) and storage apparatus 119 (storage apparatus <4>).

The image processing main chip issues requests for line data to image processing subchip <1> and image processing subchip <2> in an order specified by CPU 115. In response to this, image processing subchip <1> and image processing subchip <2> read the line data requested by the image processing main chip from output frame buffers in storage apparatus 118 (storage apparatus <3>) and storage apparatus 119 (storage apparatus <4>) respectively, and transmit this line data to the image processing main chip. The image processing main chip then performs combining of line data transmitted in line units from image processing subchips <1> and <2> and line data processed by the image processing main chip itself, using a specified order and blend ratio, and outputs the processed data to display section 114.

By synchronizing the above-described series of operations, comprising line data requests to image processing subchips <1> and <2> from the image processing main chip, line data transfer from image processing subchips, and line data combining and output to display section 114, with the line display frequency of the display section, it is possible to output combined data directly to display section 114 without the intermediation of a frame buffer, or through only the intermediation of a plurality of line buffers. By this means, delay incurred in image combining processing by each image processing chip can be suppressed, and the real-time capability of the system can be improved.

Since image processing combined main/subchip 210 has functions as an image processing main chip and functions as an image processing subchip in this way, a system can be configured in a scalable fashion simply by providing one kind of image processing chip. For example, creating an image processing combined main/subchip supporting two camera inputs makes it possible to configure an image processing system that supports four camera inputs by using two of the same chips.

According to this embodiment, in addition to being able to obtain the same kind of effects as with Embodiment 1, the use of image processing combined main/subchip 210 enables this image processing system 200 not only to be operated as a single independent system but also to be operated as a subsystem of another image processing system.

Image processing combined main/subchip 210 has an image input section 121, image processing section 122, and graphic processing section 123, but may also be configured by means of one of these processing sections plus line transfer reception processing section 124, line transfer transmission processing section 127, line-unit combining processing section 125, and image output section 126.

In this embodiment, a three-input image processing system configuration has been shown, but it is also possible, for example, to configure a two-input image processing system with an image processing main chip and one image processing subchip, or to configure a four-input image processing system using an image processing main chip and three image processing subchips, configuring a system in a scalable fashion in line with the number of image inputs, image processing load, graphic processing load, and so forth.

Also, image processing combined main/subchip 210 and image processing subchips 111 and 112 are image processing chips handling one image input, but image processing chips handling a plurality of image inputs, or image processing chips having only a graphic processing function, can also be used.

### Embodiment 3

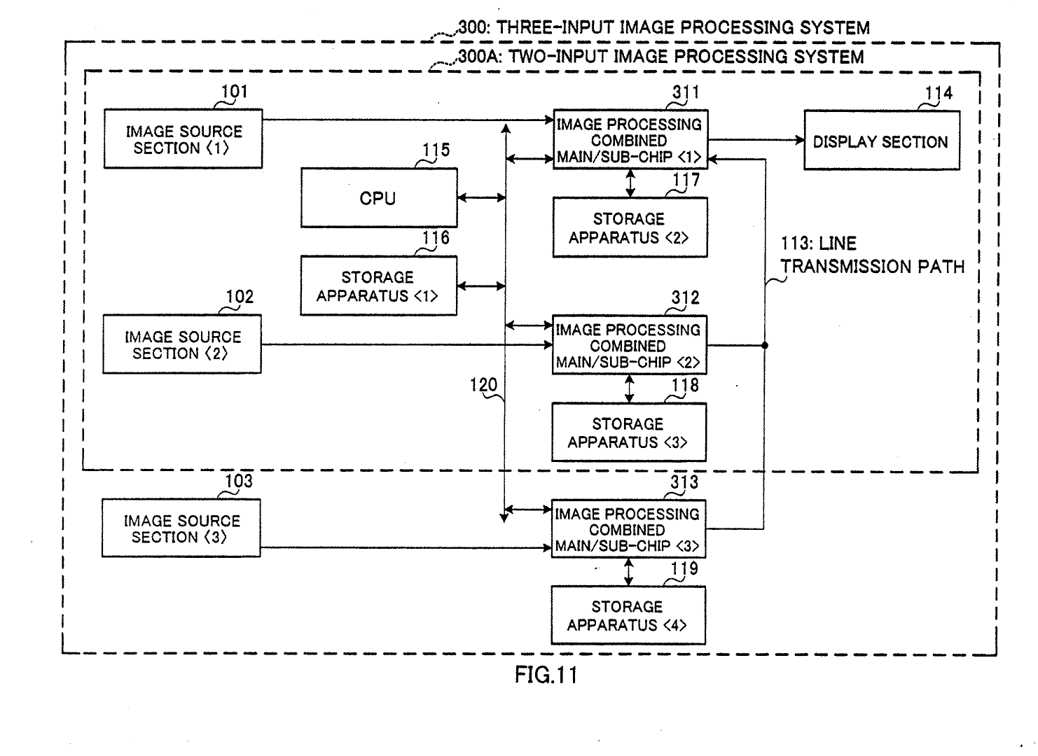

FIG. 11 is a block diagram showing the configuration of an image processing system according to Embodiment 3 of the present invention. This embodiment is an example of application of an image processing system using a plurality of image processing combined main/subchips. In the description of this embodiment, configuration parts identical to those in FIG. 9 are assigned the same reference codes as in FIG. 9, and duplicate descriptions are omitted.

In FIG. 11, a three-input image processing system 300 is configured by means of image source sections 101 through 103 (image source sections <1> through <3>), image processing combined main/subchips 311 through 313 (image processing combined main/subchips <1> through <3>) having a line-unit transfer function and line-unit combining processing function, a line transmission path 113, a display section 114, a CPU 115, storage apparatuses 116 through 119 (storage apparatuses <1> through <4>), and a bus 120.

Within three-input image processing system 300, image source section 101 (image source section <1>), image source section 102 (image source section <2>), image processing combined main/subchip 311 (image processing combined main/subchip <1>), image processing combined main/subchip 312 (image processing combined main/subchip <2>), line transmission path 113, display section 114, CPU 115, storage apparatuses 116 through 118 (storage apparatuses <1> through <3>), and bus 120, compose a two-input image processing system 300A.

Image processing combined main/subchips 311 through 313 (image processing combined main/subchips <1> through <3>) are identical in configuration to image processing combined main/subchip 210 in FIG. 10, and have both image processing main chip and image processing subchip functions. Image processing main chip functions are to request image line data from another image processing chip, collect line data, and combine the collected line data. Image processing subchip functions are to issue a response to a line data transfer request from another image processing chip, and transmit line data of the requested specification.

The operation of an image processing system configured as described above will now be explained. The basic operation is the same as in Embodiments 1 and 2.

Here, image processing combined main/subchip 311 is assumed to be the image processing main chip, and image processing combined main/subchip 312 and image processing combined main/subchip 313 are assumed to be image processing subchip <1> and image processing subchip <2>. The image processing main chip and image processing subchips are connected by line transmission path 113 so as to enable line data transfer. The image processing main chip captures image from image source section <1> and stores it in an input frame buffer in storage apparatus 117 (storage apparatus <2>).

Next, image processing specified by CPU 115 is performed on the stored image data, specified graphic processing is performed, and graphic data and image data combining processing is performed, and the processed data is stored in an output frame buffer in storage apparatus 117 (storage apparatus <2>). The same kind of processing is performed by image processing subchip <1> and image processing subchip <2> on image from image source section 102 (image source section <2>) and image source section 103 (image source section <3>) using storage apparatus 118 (storage apparatus <3>) and storage apparatus 119 (storage apparatus <4>). The image processing main chip then issues requests for line data to image processing subchip <1> and image processing subchip <2> in an order specified by CPU 115. In response to this, image processing subchip <1> and image processing subchip <2> read the line data requested by the image processing main chip from output frame buffers in storage apparatus 118 (storage apparatus <3>) and storage apparatus 119 (storage apparatus <4>) respectively, and transmit this line data to the image processing main chip.

The image processing main chip then combines line data transmitted in line units from image processing subchips <1> and <2> and line data processed by the image processing main chip itself, using a specified order or specified blend ratio, and outputs the combined data to display section 114. By synchronizing the above-described series of operations, comprising line data requests to image processing subchips from the image processing main chip, line data transfer from image processing subchips, and line data combining and output to display section 114, with line frequency for line display on display section 114, it is possible to output combined data directly to the display section without the intermediation of a frame buffer, or through only the intermediation of a plurality of line buffers, and delay incurred in combining image from each image processing subchip can be suppressed.

According to this embodiment, since image processing combined main/subchips 311 through 313 are used, it is possible to use identical image processing chips in a scalable fashion as the image processing main chip and image processing subchips. Thus, various kinds of image processing system configuration can be provided for simply by developing one kind of image processing chip, offering a major benefit in terms of device development efficiency.

Furthermore, since the image processing main chip and image processing subchips are configured as image processing combined main/subchips, interchanging of an image processing main chip and image processing subchip or the like is possible, and, for example, each image processing chip can be connected to display section 114 and can operate at times as an image processing subchip, and at other times as the image processing main chip, performing output to the display section.

In this embodiment, a three-input image processing system configuration has been shown, but it is also possible, for example, to configure a two-input image processing system with an image processing main chip and one image processing subchip, or to configure a four-input image processing system using an image processing main chip and three image processing subchips, configuring a system in a scalable fashion in line with the number of image inputs, image processing load, graphic processing load, and so forth.

Also, the image processing combined main/subchips are chips handling one image input, but image processing combined main/subchips handling a plurality of image inputs, or image processing combined main/subchips having only a graphic processing function, can also be used.

### Embodiment 4

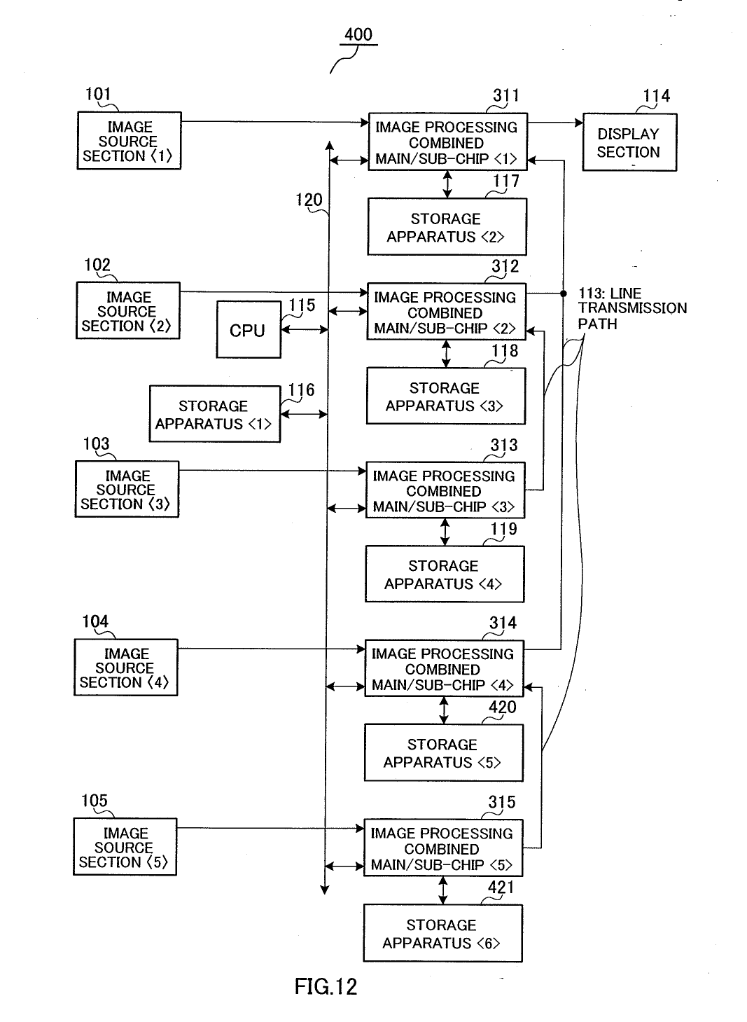

FIG. 12 is a block diagram showing the configuration of an image processing system according to Embodiment 4 of the present invention. This embodiment is an example of application of an image processing system using a plurality of image processing combined main/subchips. In the description of this embodiment, configuration parts identical to those in FIG. 11 are assigned the same reference codes as in FIG. 11, and duplicate descriptions are omitted.

In FIG. 12, a five-input image processing system 400 is configured by means of image source sections 101 through 105 (image source sections <1> through <5>), image processing combined main/subchips 311 through 315 (image processing combined main/subchips <1> through <5>) having a line-unit transfer function and line-unit combining processing function, line transmission paths 113, a display section 114, a CPU 115, storage apparatuses 116 through 119, 420, and 421 (storage apparatuses <1> through <6>), and a bus 120.

The operation of an image processing system configured as described above will now be explained. The basic operation is the same as in Embodiment 3.

Here, image processing combined main/subchip 311 is assumed to be the image processing main chip, and image processing combined main/subchip 312 and image processing combined main/subchip 314 are assumed to be image processing subchip <1> and image processing subchip <2> of image processing combined main/subchip 311. Also, image processing combined main/subchip 313 is assumed to be an image processing subchip of image processing combined main/subchip 312, and image processing combined main/subchip 315 is assumed to be an image processing subchip of image processing combined main/subchip 314, being referred to as sub image processing subchip <1> and sub image processing subchip <2> respectively.

The image processing main chip and image processing subchips <1> through <5>, and image processing subchips and sub image processing subchips, are connected by line transmission paths 113 so as to enable line data transfer. The image processing main chip captures image from image source section 101 (image source section <1>) and stores it in an input frame buffer in storage apparatus 117 (storage apparatus <2>). Then image processing specified by CPU 115 is performed on the stored image data, specified graphic processing is performed, and graphic data and image data combining processing is performed, and the processed data is stored in an output frame buffer in storage apparatus 117 (storage apparatus <2>).

The same kind of processing is performed by image processing subchip <1>, image processing subchip <2>, image processing subchip <3>, and image processing subchip <4> on image from image source section 102 (image source section <2>), image source section 104 (image source section <4>), image source section 103 (image source section <3>), and image source section 105 (image source section <5>), using storage apparatus 118 (storage apparatus <3>), storage apparatus 420 (storage apparatus <5>), storage apparatus 119 (storage apparatus <4>), and storage apparatus 421 (storage apparatus <6>).

The image processing main chip issues requests for line data to image processing subchip <1> and image processing subchip <2> in an order specified by CPU 115. The image processing subchips then transmit the corresponding line data to the image processing main chip. Next, the image processing main chip combines line data transmitted in line units from the image processing subchips and line data processed by the image processing main chip itself, in a specified order, and outputs the processed data to the display section.

On the other hand, between an image processing subchip and sub image processing subchip, a request is first made from the image processing subchip to the sub image processing subchip for line data in a specified order. The sub image processing subchip reads the line data requested by the image processing main chip from an output frame buffer, and transmits that line data.

The image processing subchips then combine line data from the sub image processing subchips with image data processed by the image processing subchips themselves, and temporarily store the combined data in a line buffer or transmit the combined data directly to the image processing main chip. The series of operations comprising a data request to a sub image processing subchip from an image processing subchip, line data transfer from a sub image processing subchip to an image processing subchip, and processing to combine line data from sub image processing subchips by the image processing subchips, and the series of operations comprising line data requests to image processing subchips from the image processing main chip, line data transfer from sub image processing subchips to the image processing main chip, and processing to combine line data from image processing subchips and output to display section 114 by the image processing main chip, are synchronized with the line display frequency of display section 114. By this means, it is possible to combine image from all chips without the intermediation of a frame buffer, and delay incurred in image combining can be suppressed.

Thus, according to this embodiment, the delay between image input and image output can be minimized by using the line transfer function even when a system is given a hierarchical structure. When a system is configured by giving a conventional system a hierarchical structure, the number of times a frame buffer is used increases accordingly, and overall system delay increases. In this embodiment, the delay between image input and image output when a system is given a hierarchical structure can be significantly reduced.

In this embodiment, a five-input image processing system configuration has been shown, but a system can be configured in a scalable fashion by increasing or decreasing the number of layers in line with the number of image inputs, image processing load, graphic processing load, and so forth. An image processing system capable of handling multiple image inputs can be configured by using this kind of configuration.

Also, the image processing combined main/subchips are image processing chips handling one image input, but image processing chips handling a plurality of image inputs, or image processing chips having only a graphic processing function, can also be used.

### Embodiment 5

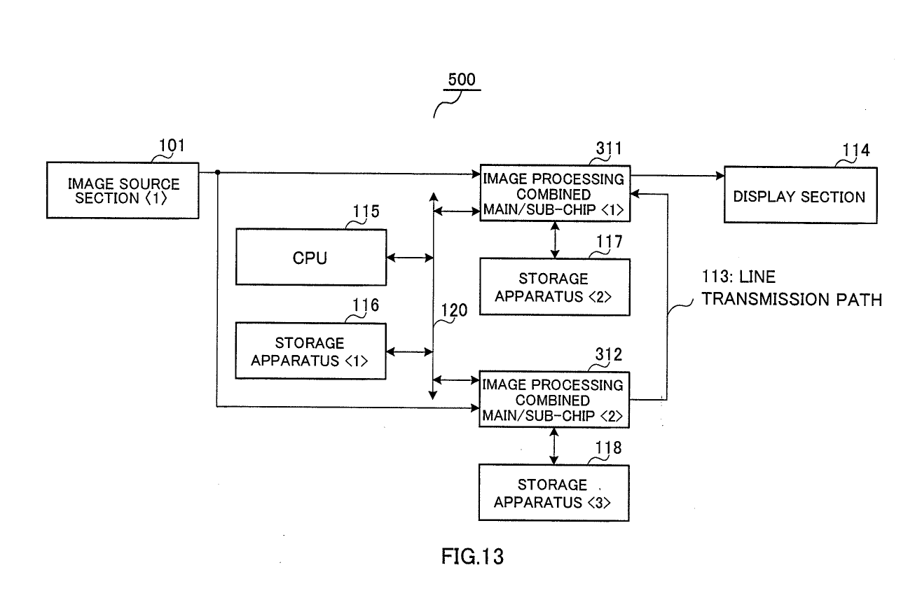

FIG. 13 is a block diagram showing the configuration of an image processing system according to Embodiment 5 of the present invention. This embodiment is an example of application of an image processing system using a plurality of image processing combined main/subchips. In the description of this embodiment, configuration parts identical to those in FIG. 9 are assigned the same reference codes as in FIG. 9, and duplicate descriptions are omitted.

In FIG. 13, an image processing system 500 is configured by means of an image source section 101 (image source section <1>), image processing combined main/subchips 311 and 312 (image processing combined main/subchips <1> and <2>) having a line-unit transfer function and line-unit combining processing function, a line transmission path 113, a display section 114, a CPU 115, storage apparatuses 116 through 118 (storage apparatuses <1> through <3>), and a bus 120.

The operation of an image processing system configured as described above will now be explained.

Here, image processing combined main/subchip 311 is assumed to be the image processing main chip, and image processing combined main/subchip 312 is assumed to be an image processing subchip. The image processing main chip and image processing subchip are connected by line transmission path 113 so as to enable line data transfer.

The image processing main chip captures image from image source section 101 (image source section <1>) and stores it in an input frame buffer in storage apparatus 117 (storage apparatus <2>). Next, image processing specified by CPU 115 is performed on the stored image data, specified graphic processing is performed, and graphic data and image data combining processing is performed, and the processed data is stored in an output frame buffer in storage apparatus 117 (storage apparatus <2>).

The same kind of processing is also performed by the image processing subchip on image from image source section 101 (image source section <1>) using storage apparatus 118 (storage apparatus <3>). The image processing main chip then issues a request for line data to the image processing subchip. In response to this, the image processing subchip reads the requested line data from output frame memory in storage apparatus 118 (storage apparatus <3>), and transmits this line data to the image processing main chip.

The image processing main chip then combines and compares line data transmitted from the image processing subchip and line data processed by the image processing main chip itself, and outputs the combined data to display section 114.

According to image processing system 500, it is possible, for example, to have the upper half of a screen (processing area) processed by the image processing main chip, and the lower half processed by the image processing subchip. This enables the processing load of each image processing chip to be halved compared with a case in which the entire screen is processed by a single chip, and makes it possible, for example, to perform processing with two chips even when the screen size (or image resolution) is doubled. Incorporating processing of one image input in a plurality of image processing chips and distributing the load among the plurality of image processing chips in this way enables higher-resolution input image and higher definition display output to be supported.

Application of this embodiment to a case in which two chips perform the same image processing on one image input will now be described.

Here, it is assumed that an image processing main chip and image processing subchip are identical chips—that is to say, have the same processing functions. When the image processing main chip and image processing subchip perform the same processing on the same input image, the image processed by each image processing chip is the same. Making use of this fact, erroneous display can be prevented and a more reliable image processing system can be implemented by issuing a line data request to the image processing subchip before the image processing main chip outputs its processing results to display section 114, and comparing and checking whether or not the processing results of the image processing main chip and the processing results of the image processing subchip are the same on a line-by-line basis. For example, the use of image processing system 500 in an in-vehicle cameran image system for supporting vehicle driving enables erroneous display due to a system malfunction or the like to be prevented, and is effective in improving safety.

Also, by capturing a single camera input image in a plurality of image processing chips, generating the same image by means of identical processing by each image processing chip, and performing processing to compare the images generated by each image processing chip, or the like, erroneous display due to a system malfunction or the like can be prevented, and system reliability can be improved.

It is also possible to capture a single camera input image in a plurality of image processing chips, have the same image processing performed by each chip, transfer the processing results to a main chip in line units, and have the respective image processing results compared by the image processing main chip.

### Embodiment 6

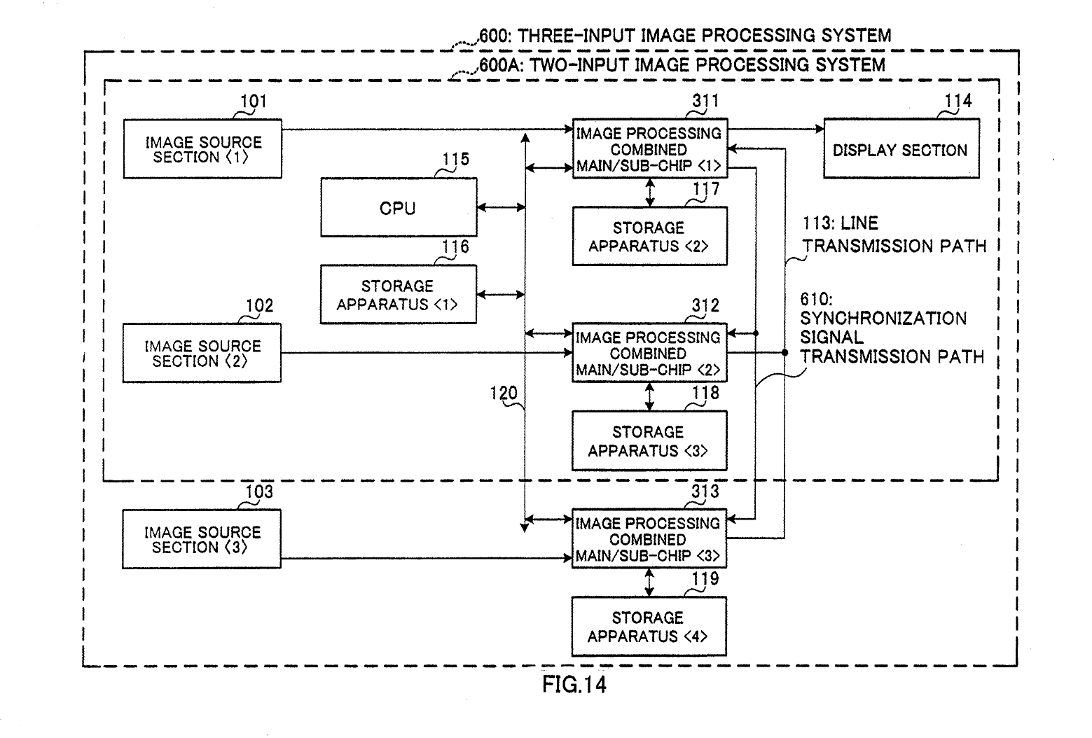

FIG. 14 is a block diagram showing the configuration of an image processing system according to Embodiment 6 of the present invention. This embodiment is an example of application of an image processing system using a plurality of image processing combined main/subchips. In the description of this embodiment, configuration parts identical to those in FIG. 11 are assigned the same reference codes as in FIG. 11, and duplicate descriptions are omitted.

In FIG. 14, a three-input image processing system 600 is configured by means of image source sections 101 through 103 (image source sections <1> through <3>), image processing combined main/subchips 311 through 313 (image processing combined main/subchips <1> through <3>) having a line-unit transfer function and line-unit combining processing function, a line transmission path 113, a synchronization signal transmission path 610, a display section 114, a CPU 115, storage apparatuses 116 through 119 (storage apparatuses <1> through <4>), and a bus 120.

Within three-input image processing system 600, image source section 101 (image source section <1>), image source section 102 (image source section <2>), image processing combined main/subchip 311 (image processing combined main/subchip <1>), image processing combined main/subchip 312 (image processing combined main/subchip <2>), line transmission path 113, synchronization signal transmission path 610, display section 114, CPU 115, storage apparatuses 116 through 118 (storage apparatuses <1> through <3>), and bus 120, compose a two-input image processing system 600A.

Synchronization signal transmission path 610 is a transmission path whereby an image processing main chip provides a processing synchronization signal to an image processing subchip. Examples of processing synchronization signals are display horizontal synchronization and vertical synchronization signals.

The operation of an image processing system configured as described above will now be explained.

Here, image processing combinedmain/subchip 311 is assumed to be the image processing main chip, and image processing combinedmain/subchip 312 and image processing combined main/subchip 313 are assumed to be image processing subchip <1> and image processing subchip <2>. The image processing main chip and image processing subchips are connected by line transmission path 113 so as to enable line data transfer.

In this embodiment, the image processing main chip provides a processing synchronization signal to the image processing subchips via synchronization signal transmission path 610. In the previously described embodiments, image processing of each image processing chip is asynchronous, and therefore processed image is written back temporarily to an output frame buffer in each image processing chip, and in line data exchange between chips it is necessary to eliminate the phase difference of processing between chips by reading the data in this frame buffer and transferring it to the image processing main chip.

In an image processing system according to this embodiment, the image processing main chip provides a processing synchronization signal to the image processing subchips, and the image processing main chip and image processing subchips perform line-unit image processing in accordance with horizontal synchronization (the display line frequency). By this means, the image processing main chip and image processing subchips can always perform processing of the same-numbered line, and line data generated by each image processing chip can be directly collected and combined. Therefore, in this embodiment, in contrast to image processing systems according to the previously described embodiments, exchanging of line data to be combined can be performed without the intermediation of an output frame buffer, enabling the delay between image capture and display output to be further reduced, and system real-time capability to be significantly improved.

Also, since operations to write and read processed data to and from output frame memory are eliminated in each image processing chip, accesses to storage apparatuses are reduced, and overall system performance in image processing and so forth can be improved.

In particular, providing a line frequency or suchlike synchronization signal to each image processing chip and synchronizing the processing of all the image processing chips enables screen combining processing to be performed without the intermediation of an output frame buffer.

Thus, in this embodiment, a synchronization signal is passed from an image processing main chip to image processing subchips and image processing is performed by the respective image processing chips synchronized in line units, transfer is performed to the image processing main chip, and the image processing main chip performs combining and display. In this case, a mode may also be used whereby transfer area information of each image processing subchip is extracted from data area information of each line stored in the image processing main chip, a transfer request is made to each image processing chip, and only valid data necessary for combining is transferred to the image processing main chip, combined, and displayed. Furthermore, a mode may also be used whereby only valid data necessary for combining is transferred to the image processing main chip based on data area information of each line stored in each image processing chip, and then combined and displayed.

### Embodiment 7

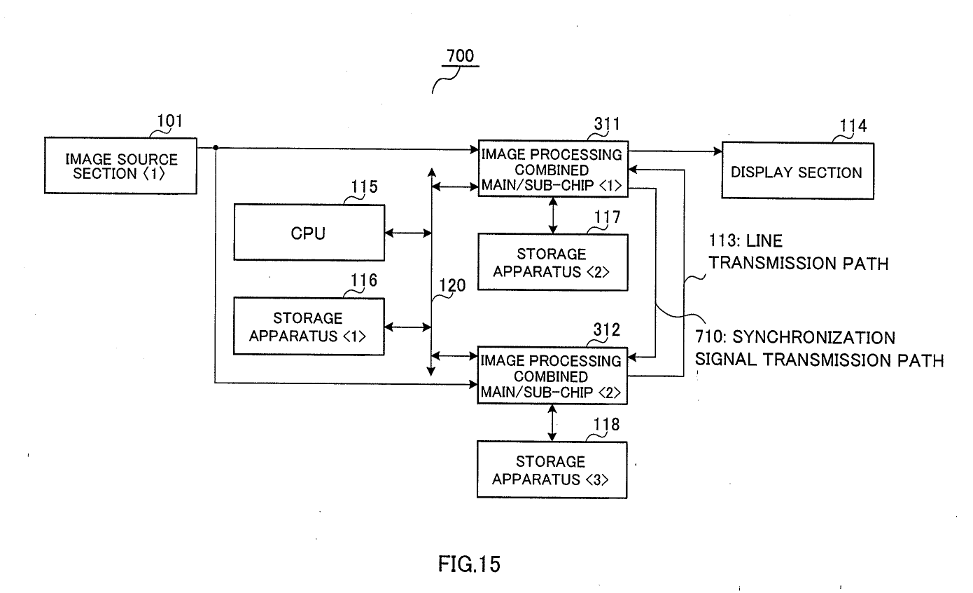

FIG. 15 is a block diagram showing the configuration of an image processing system according to Embodiment 7 of the present invention. This embodiment is an example of application of an image processing system using a plurality of image processing combined main/subchips. In the description of this embodiment, configuration parts identical to those in FIG. 13 are assigned the same reference codes as in FIG. 13, and duplicate descriptions are omitted.

In FIG. 15, an image processing system 700 is configured by means of an image source section 101 (image source section <1>), image processing combined main/subchips 311 and 312 (image processing combined main/subchips <1> and <2>) having a line-unit transfer function and line-unit combining processing function, a line transmission path 113, a synchronization signal transmission path 710, a display section 114, a CPU 115, storage apparatuses 116 through 118 (storage apparatuses <1> through <3>), and a bus 120.

Synchronization signal transmission path 710 is a transmission path whereby an image processing main chip provides a processing synchronization signal to an image processing subchip. Examples of processing synchronization signals are display horizontal synchronization and vertical synchronization signals.

The operation of an image processing system configured as described above will now be explained.

Here, image processing combined main/subchip 311 is assumed to be the image processing main chip, and image processing combined main/subchip 312 is assumed to be an image processing subchip. The image processing main chip and image processing subchip are connected by line transmission path 113 so as to enable line data transfer. The image processing main chip provides a processing synchronization signal to the image processing subchip via synchronization signal transmission path 710.

The image processing main chip can synchronize line-unit processing by the image processing main chip and image processing subchip by providing a processing synchronization signal to the image processing subchip. That is to say, the image processing main chip and image processing subchip can always perform processing of the same-numbered line. In this embodiment, image from one image source section <1> is captured by the image processing main chip and the image processing subchip, stored in an input frame buffer, and then processed with the load distributed between the image processing main chip and image processing subchip.

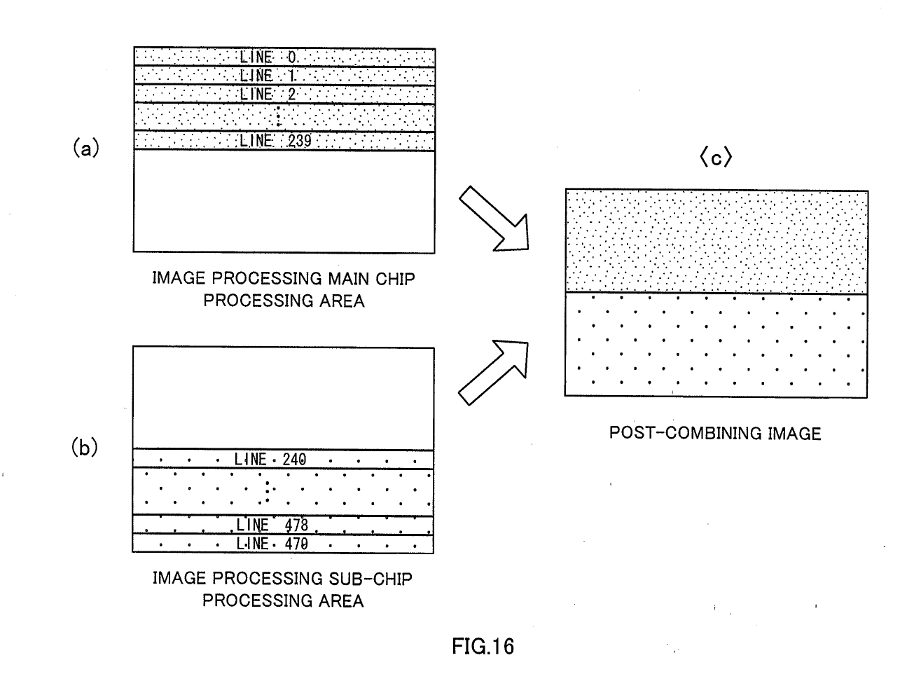

FIG. 16 is a drawing showing an example of a case in which image processing division is performed in the screen horizontal direction, with FIGS. 16(a) and (b) showing the image processing main chip processing area and image processing subchip processing area, and FIG. 16(c) showing an image after combining by the image processing main chip.

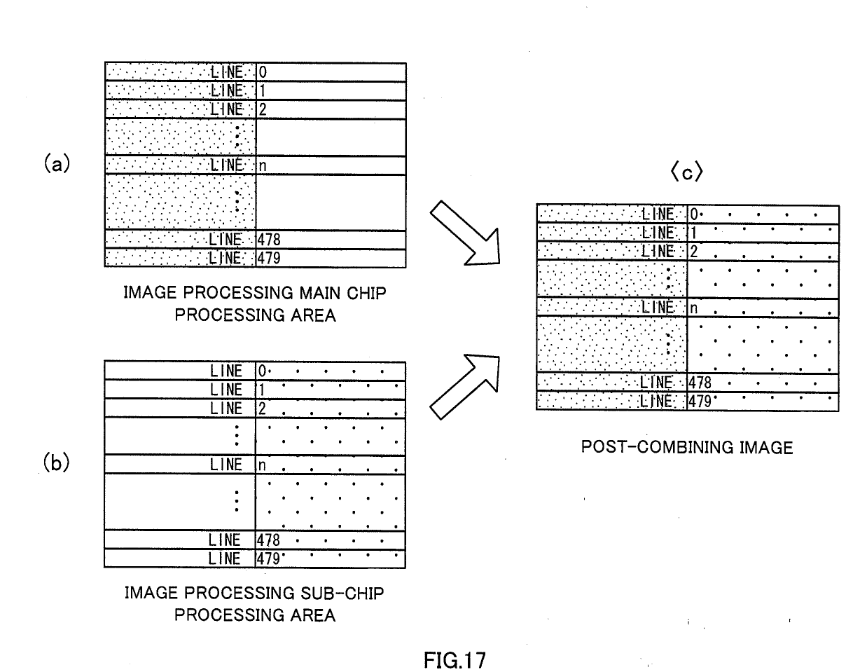

FIG. 17 is a drawing showing an example of a case in which image processing division is performed in the screen vertical direction, with FIG. 17(a) and (b) showing the image processing main chip processing area and image processing subchip processing area, and FIG. 17(c) showing an image after combining by the image processing main chip.

For example, the image processing main chip and image processing subchip processing areas are divided in the screen horizontal direction as shown in FIGS. 16(a) and (b), with the upper half of the screen being processed by the image processing main chip and the lower half of the screen being processed by the image processing subchip. As a result, since the image processing main chip and image processing subchip always perform processing of the same line as explained above, when upper-half lines are processed the image processing main chip performs one-line processing for the respective lines, and the image processing subchip is idle at this time. Similarly, when the lower half of the screen is processed the image processing subchip performs one-line processing for the respective lines, and the image processing main chip is idle. Therefore, when inter-chip processing is synchronized, system performance cannot be improved by distributing the processing load by means of image processing division in the screen horizontal direction as shown in FIG. 16.

Thus, in this embodiment, the image processing main chip and image processing subchip processing areas are divided in the screen vertical direction as shown in FIG. 17, with the left half of the screen being processed by the image processing main chip and the right half of the screen being processed by the image processing subchip. In this way, the line-by-line processing load for the entire screen is distributed efficiently between the image processing main chip and the image processing subchip, and system performance can be improved.

### Line Transfer Example 1

In FIG. 15, image processing system 700 performs processing of image from one image source section <1> by means of an image processing main chip and an image processing subchip. It is assumed here that the area processed by the image processing main chip is the left half of the screen, and the area processed by the image processing subchip is the right half of the screen. CPU 115 provides left screen half image processing parameters and combining processing parameters to the image processing main chip, and provides right-half image processing parameters to the image processing subchip. An image processing parameter contains information as to which screen area is to be processed, which pixel data of the original image is to be used, and so forth. A line combining processing parameter contains information as to what kind of blend ratio is to be used in performing combining, what pixel data of what image processing subchip line data is to be used, and so forth.

The image processing main chip and image processing subchip perform image processing based on the image processing parameters provided to each. Then the image processing main chip performs combining processing based on the parameters, extracts information as to which area of a line is valid data for the image processing subchip from combining processing parameter information, and when making a line data request to the image processing subchip, also provides the extracted line valid area information to the image processing subchip. In this example, the fact that the right half of a line is valid data is conveyed to the image processing subchip. Based on the line valid area information from the image processing main chip, the image processing subchip transfers only valid data (right-half line data) to the image processing main chip.

By having the image processing main chip request line data from the image processing subchip while providing line valid area information to the image processing subchip in this way, wasteful data transfer between the image processing main chip and image processing subchip is eliminated, and efficient transfer can be performed. This method is particularly useful in a system with a large number of image processing subchips.

### Line Transfer Example 2

In FIG. 15, image processing system 700 performs processing of image from one image source section <1> by means of an image processing main chip and an image processing subchip. It is assumed here that the area processed by the image processing main chip is the left half of the screen, and the area processed by the image processing subchip is the right half of the screen. CPU 115 provides left screen half image processing parameters and combining processing parameters to the image processing main chip, and provides right screen half image processing parameters and a line transfer processing parameter to the image processing subchip. The line transfer processing parameter contains information as to which area is valid data for a specified line.

The image processing main chip and image processing subchip perform image processing based on the image processing parameters provided to each. Then, by means of line-unit combining processing section 125, the image processing main chip issues a line data request to the image processing subchip. The image processing subchip transfers corresponding valid data based on a provided line transfer information parameter. By providing the image processing subchip with a line transfer information parameter in this way, wasteful data transfer between the image processing main chip and image processing subchip is eliminated, and efficient transfer can be performed. This method is useful in a system with a large number of image processing subchips.

As compared with above example 1, this method does not require the transfer of line valid area information from the image processing main chip to the image processing subchip, and thus has an effect of improving transfer efficiency correspondingly.

A mode may also be used whereby a single camera input image is captured in a plurality of image processing chips, image processing is performed by each image processing chip divided in the vertical direction of the screen, the processing load for one line is distributed, and only the respective divided areas are transferred to the image processing main chip, and are combined and displayed by the image processing main chip.

The above descriptions are illustrations of preferred embodiments of the present invention, and the scope of the present invention is not limited to these.

In these embodiments the term “image processing system” has been used, but this is simply for convenience in describing the embodiments, and terms such as “image processing apparatus,” “image processing method,” or the like may, of course, also be used.

The type, number, connection method, and so forth of circuit sections—such as image source sections, for example—configuring an above-described image processing system are not limited to those in the above embodiments.

As described above, according to the present invention processing of input image is distributed using a plurality of image processing chips having an image line-unit transfer function, image processed by the respective chips is transferred to a main chip in line units, and is combined in line units and output by the main chip, enabling combining processing of image from a plurality of chips to be performed without the intermediation of a frame buffer, the delay between image input and display to be reduced, and real-time capability to be improved.

Also, since image processing chips having an image line-unit transfer function are used, a system can be constructed in a scalable fashion in line with the number of image inputs, image processing load, and so forth.

Thus, an image processing apparatus according to the present invention enables an image processing system to be configured in a scalable fashion by using a plurality of image processing chips having an image line-unit transfer function, and is therefore useful in coping with the diversification or performance upgrading of image processing system functions and/or needs. Also, an image processing apparatus according to the present invention can perform combining processing of image from a plurality of chips without the intermediation of a frame buffer by using line-unit transfer, and is therefore useful for image processing systems for which real-time capability is required (such as in-vehicle camera ECU systems making rapid advances in terms of functions and performance, for example).

What is claimed is:

1. An image processing apparatus comprising:
one or a plurality of image sources that supply image composed of frame-unit images;
a plurality of image processing sections that process image from said image source(s);
a storage section that has a frame buffer that stores one screen of input image; and
a display section that displays image data that has undergone image processing by said image processing section, wherein:
said image processing section is composed of:
a first image processing section that reads image data stored in said frame buffer in line units in accordance with a line frequency of said display section, performs combining processing of that image data in line units, and outputs that image data to said display section; and
a second image processing section that does not perform said combining processing, and
said first and second image processing sections are equipped with a data transfer section that transfers image in line units in accordance with a line frequency of said display section.

2. The image processing apparatus according to claim 1, wherein said first image processing section collects, in said line units, image data processed by said second image processing section, performs combining processing of collected image data in said line units, and outputs resulting image data to said display section.

3. The image processing apparatus according to claim 1, wherein said second image processing section sends processed image data to said first image processing section in said line units.

4. The image processing apparatus according to claim 1, wherein said first image processing section comprises a synchronization section that provides synchronization signals to said second image processing section, and synchronizes image processing by said first image processing section and image processing by said second image processing section in said line units.

5. The image processing apparatus according to claim 4, wherein said synchronization signals are a horizontal synchronization signal and vertical synchronization signal of said display section.

6. The image processing apparatus according to claim 1, wherein:
said plurality of image processing sections correspond respectively to said plurality of image sources; and
said plurality of image processing sections capture respectively input image from said image sources.

7. The image processing apparatus according to claim 1, wherein said plurality of image processing sections capture input image from said one image source, and perform distributed processing of image data captured from said one image source.

8. The image processing apparatus according to claim 1, wherein:
said first image processing section is composed of an image processing main chip; and
said second image processing section is composed of an image processing subchip.

9. The image processing apparatus according to claim 1, wherein said first and second image processing sections are composed of image processing combined main/subchips that perform said line-unit combining processing.
